(19) United States
(12) Patent Application Publication
(10) Pub. No.: US 2026/0113296 A1
(43) Pub. Date: Apr. 23, 2026

(54) USER DIRECTED CONTROL OF SOCIAL MEDIA CONTENT FEED

(71) Applicant: LikeUs Media, LLC, Atlanta, GA (US)

(72) Inventors: Mazy Holiday, Atlanta, GA (US); Gregory Sarafin, Atlanta, GA (US)

(73) Assignee: LikeUs Media, LLC, Atlanta, GA (US)

(21) Appl. No.: 18/923,943

(22) Filed: Oct. 23, 2024

(51) Int. Cl. H04L 51/52; G06F 16/31; G06Q 50/00

(52) U.S. Cl. CPC H04L 51/52; G06F 16/316; G06Q 10/40

(57) ABSTRACT

Systems and methods are disclosed that include determining a user content feed for an individual user; transmitting the user content feed to the client device of the user for display of individual content items of the user content feed in succession; receiving a request to modify the queue of content items for the user content feed, wherein the request includes one or more contextual identifiers associated with a displayed content item; determining a modified user content feed for the individual user based on the one or more contextual identifiers associated with a displayed content item; and transmitting the modified user content feed to the client device of the user for display of individual content items of the user content feed in succession.

### TECHNICAL FIELD

The present disclosure relates to systems and methods for control of social media content feed. More particularly, the present disclosure relates to systems and methods for real-time user directed control of subsequent content items that are presented in the user's social media content feed.

### BACKGROUND

Social media allows individuals to share experiences with each other permanently, instantly, and in real-time via social networking sites, virtual opinion-sharing platforms, or video-sharing portals. Articulating their experiences helps sharing individuals understand the causes and consequences of their experiences. Sharing one's own experiences with other individuals online supports the development of social capital as it helps individuals connect with peers and build social bonds.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a schematic block diagram of a social networking platform in a networked environment according to various embodiments.

FIG. 2 illustrates an example scenario showing a content feed in a user interface displayed in a client of the networked environment of FIG. 1 according to various embodiments.

FIG. 3 illustrates another example scenario involving a displayed content item in full screen mode in the client of the networked environment of FIG. 1 according to various embodiments.

FIG. 4 illustrates an example diagram of context paths for the displayed content of FIGS. 2 and 3 according to various embodiments.

FIG. 5 is a flowchart illustrating one example of functionality implemented as portions of the social media application executed in a client of in the networked environment of FIG. 1 according to various embodiments.

FIG. 6 is a flowchart illustrating one example of functionality implemented as portions of the social media application executed in a social media platform of in the networked environment of FIG. 1 according to various embodiments.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, and/or components have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

Disclosed herein are various embodiments of systems and methods for user initiated control of digital content items presented in a user content feed by a social network platform. The social network platform is configured to connect a plurality of client devices, where a social media client application is executed on individual client devices to allow individual users to network and share ideas and experiences. The user content feed may also be referred to as a digital feed, digital feed stream, digital stream, social activity feed, social media feed, social media stream, user stream, user feed, and other similar terminology. The user content feed includes an ordered presentation of digital content curated for and presented to an individual user. As described herein, a user content feed includes a sequence of content items queued for display on a client device within a user interface of client application associated with the social network platform. An individual digital content item can include one or more forms of social media content, which includes graphics, photographs, images, audio, video, blogs, text, articles, and other multimedia, and other digital information or material that is created, posted, or transmitted using social media.

The systems and methods described herein provide a user with immediate, contextual, and dynamic control over the nature and priority of the content items of the content feed being served to the user's device by the social network platform. Further, the systems and methods are integrated into the core flow of the social media experience, not as a separate mechanism or setting. For example, although users can globally set preferences in associated user profiles to guide the artificial intelligence (AI) powered content-provisioning algorithms of the social network platform, the systems and methods described herein allow for the user to update the content feed in real-time based at least in part by an individual content item the user is viewing. In various embodiments, the information associated with the updated content feed can be included as training data for the order or prioritization of digital content in future digital feeds for the user.

This level of user control and contextual convenience targets the limitations of current social media platforms that provide a single path to content optimized by AI for the user's viewing behaviors and preferences. The systems and methods described herein do not eliminate the use of such AI techniques to serve content that the user is likely to find compelling. Rather, it gives the user a significantly improved experience of the platform, allowing the user freedom to be more directive in what is presented, and to be focused on the specific topic areas that are of interest to the user “in the moment”, not just what the AI algorithm calculates on a generic basis. The systems and methods described herein provide a mechanism for the user to dynamically direct and update content feed for subsequently presented digital content items.

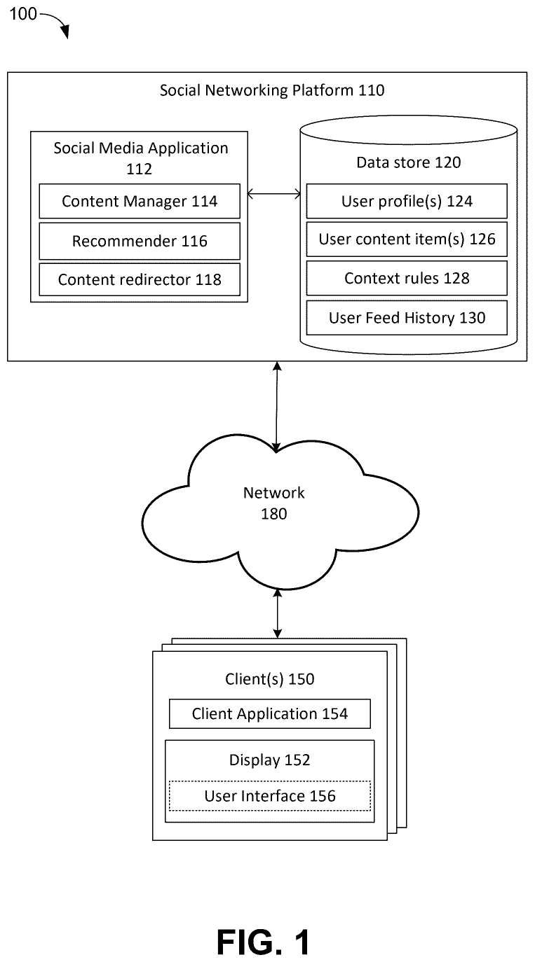

With reference to FIG. 1, shown is a networked environment 100 according to various embodiments. The networked environment 100 includes a social networking platform 110 and at least one client 150, which are in data communication with each other via a network 180. The network 180 includes, for example, the Internet, intranets, wireless networks, mobile networks, cable networks, satellite networks, or other suitable networks, etc., or any combination of two or more such networks.

The social networking platform 110 may comprise a computing device that includes at least a processor and a memory, for example, a server computer or any other system providing computing capability. Alternatively, the social networking platform 110 may employ a plurality of computing devices that may be arranged, for example, in one or more server banks or computer banks or other arrangements. Such computing devices may be located in a single installation or may be distributed among many different geographical locations. For example, the social networking platform 110 may include a plurality of computing devices that together may comprise a hosted computing resource or any other distributed computing arrangement. For example, the social networking platform 110 may be configured to operate in a cloud-computing environment.

Various applications and/or other functionality may be executed in the social networking platform 110 according to the various embodiments. Also, various data is stored in a data store 120 that is accessible to the social networking platform 110. The data store 120 may be representative of a plurality of data stores 120 as can be appreciated. The data stored in the data store 120, for example, is associated with the operation of the various applications and/or functional entities described below.

The components executed on the social networking platform 110, for example, include social media application 112, content manager 114, recommender 116, content redirector 118, and other applications, services, processes, systems, engines, or functionality not discussed herein. The social media application 112 is executed to provide an interface to and communication among a plurality of clients 150 and the social networking platform 110. The content manager 114 is executed to deliver a content feed to individual clients 150. In various embodiments, the content manager 114 may include or be communicatively coupled to a recommender 116 that is executed to analyze the individual user profile, preferences, and other information to recommend individual content items. For example, the recommender 116 can utilize algorithms, machine learning, and/or artificial intelligence to recommend user content based on at least the individual user profile data 124. The content redirector 118 is executed to utilize contextual information 170 of a content item 126 to modify or update the content feed provided by the content manager 114 in response to input received from the client 150.

The data stored in the data store 120 includes, for example, user profile data 124, user content items 126, context rules 128, user feed history 130, and potentially other data. The user profile data 124 can include demographic and other characteristic information about the individual user, as well as the user's activities, interests, views, purchasing habits, and online behaviors. The user content items 126 can include one or more forms of social media content, which includes graphics, photographs, images, audio, video, blogs, text, articles, and other multimedia, and other digital information or material that is created, posted, or transmitted using social media. The context rules 128 can contain information for determining the contextual options for content items. For example, the context rules 128 can include goals for an AI agent to determine the content feed. The user feed history 130 can include feed information related to the user content feed determined by the recommender 116 based on the individual user profile 124 and/or other information, redirect history information based on the user request to modify the content feed, and information related to the modified user content feed. The user feed history 130 user feed history can include information related to a plurality of previous requests to modify the queue of content items for the user content feed. Additional data can include application data related to the operation of the social media application 112 among other information.

The content manager 114 is executed to deliver a content feed to individual clients 150. In various embodiments, the content manager 114 may include or be communicatively coupled to a recommender 116 that is executed to analyze the individual user profile, preferences, and other information to recommend individual content items. The content manager 114 of the social networking platform 110 can generate a content feed 160 that includes a sequence of individual content items 126 that are ordered and prioritized based on information generated by the recommender 116 and/or the content redirector 118.

The recommender 116 can curate the content feed 160 from the content items 126 stored in the data store 120. For example, the recommender 116 can utilize algorithms, machine learning, and/or artificial intelligence to recommend user content based on at least the individual user profile data 124. An algorithm that evaluates information regarding the user including user habits, user interests, user activities, among other information. In various examples, the recommender 116 can utilize AI powered content-provisioning algorithms of the social network platform.

The content redirector 118 is executed to modify or update the content feed provided by the content manager 114 in response to input received from the client 150. The content redirector 118 can utilize context rules 128 and information associated with the individual content item 126 to suggest contextual options for a different contextual path for the user content feed 160. The contextual information 170 may be included in metadata associated with the content item 126 and/or the social media post 162. The metadata can include descriptive, administrative, and/or structural information about the content item 126 and/or the social media post 162. For example, the contextual information 170 can include name of posting users, geographic location, nature of the activity, emotion, and format of content item, among others. The contextual information 170 may also be information included in a social media post 162 provided by the user posting the information or another user providing feedback. In some embodiments, a set of contextual options 174 may be provided with the content item 126 and/or the social media post 162 and suggested to the user via the user interface 156 (e.g. overlay selections on content item, provided in a drop down selection, via clickable text within the structure of the social media post, text input, voice input, etc.). For example, the contextual options may be selected from contextual identifiers associated with the top few metadata elements from the content item may be presented to the user. In various embodiments, the user can determine a contextual option without being prompted by content redirector 118. In various embodiments, the user can input contextual identifier 172 not related to the currently presented content item 126.

The client 150 is representative of a plurality of clients that may be coupled to the network 180. The client 150 may comprise, for example, a processor-based system such as a computing device that includes at least a processor and a memory. Such a computing device may be embodied in the form of a desktop computer, a laptop computer, personal digital assistants, cellular telephones, smartphones, tablet computer systems, game consoles, electronic book readers, smartwatches, head mounted displays, voice interface devices, or other devices. The client 150 may include a display 152. The display 152 may comprise, for example, one or more devices such as a liquid crystal display (LCD), organic light emitting diode (OLED) displays, electrophoretic ink (E ink) displays, or other types of display devices, etc. In some examples, the client 150 may be configured for augmented reality (AR) or virtual reality (VR) and a user wearable display.

The client 150 may be configured to execute various applications such as a client application 154 and/or other applications. The client application 154 may be executed in a client 150, for example, to access network content served up by a social networking platform 110 and/or other server, thereby rendering a user interface 156 on the display 152. To this end, the client application 154 may comprise a network page, an application screen, etc. The client 150 may be configured to execute applications beyond the client application 154, such as, for example, email applications, other social networking applications, word processors, spreadsheets, and/or other applications.

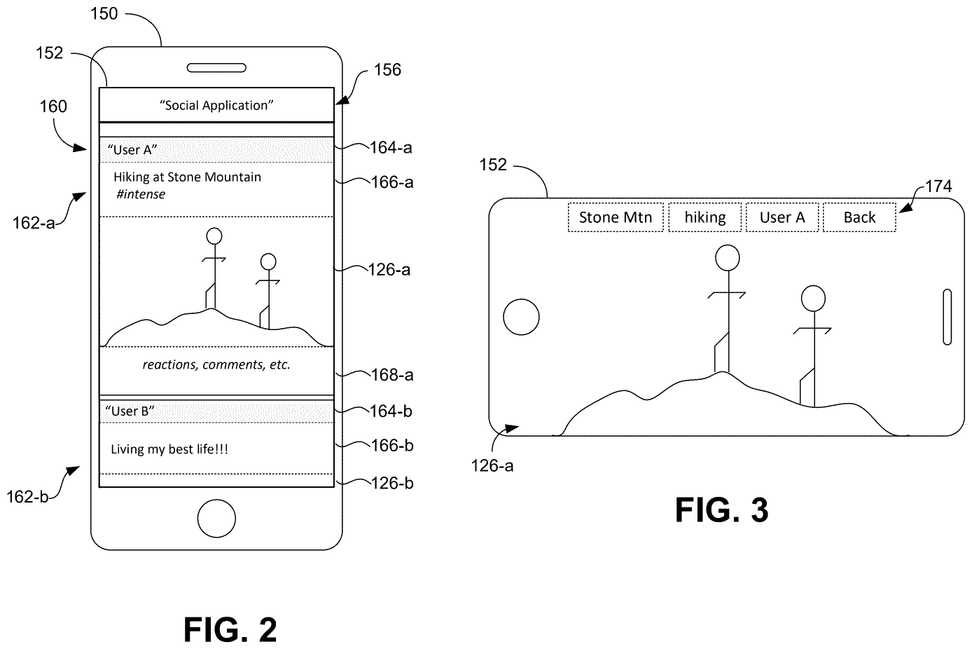

The client application 154 can render a user interface 156 on the display 152 of the client 150. The user interface 156 can include features of the client application 154 to display the user content feed 160 (FIG. 2) of received from content manager 114 the social networking platform 110. The user content feed 160 includes a sequence of individual content items 126 curated for the individual user. An individual content item 126 can be embodied in a social media post 162 which can contain the individual content item 126 and additional information or reference to additional information. In various embodiments, as shown in FIG. 2, a social media post 162 can include a header 164, a caption 166, a content item 126, a feedback section 168, among other features. The header 164 can display information related the user posting the content item 126, such as the user name, an image (e.g. photo or avatar), a title, a timestamp, and the like. The caption 166 can include text, emojis, tags, links, and other information added by the user posting the content item 126. The feedback section 168 can include text and other feedback (e.g. reactions, comments, etc.) from users viewing the social media post. The social media post 162 can also include contextual information 170, that may or may not be viewable by a user. For example, contextual information 170 may be included in at least one of the header 164, caption 166, content item 126, and/or feedback section 168. Additionally, contextual information 170 may be included in metadata associated with the content item 126 and/or the social media post 162. The metadata can include descriptive, administrative, and/or structural information about the content item 126 and/or the social media post 162. For example, the contextual information 170 can include name of posting users, geographic location, nature of the activity, emotion, and format of content item, among others.

For example, as illustrated in the non-limiting example of FIG. 2, the user content feed 160 can be displayed in the user interface 156. As shown, the content feed 160 can include a first social media post 162-a and a second social media post 162-b, where the first social media post 162-a is shown within a substantial portion of the display 152 and the a second social media post 162-b is partially shown. In this example, although the second social media post 162-b is partially shown, the first social media post 162-a is considered the displayed social media post 162 or displayed content item 126 (also referred to as identified content or content in focus). For the first social media post 162-a, the contextual information 170 can include the geographic location (e.g. Stone Mountain); the nature of the activity associated with the content (e.g. hiking); the user who posted the content (e.g. User A); the emotion of the activity associated with the content (e.g. intense); and/or the format of the content (e.g. long video). In some embodiments, the content redirector 118 can identify the contextual information 170 and present it to the user via the user interface 156. In some embodiments, the user can select the presented contextual information 170 or input contextual information 170. In some embodiments, the user can input the contextual information 170 by speaking the contextual identifier(s), with or without displayed contextual information 170.

In FIG. 3, another embodiment shows the content item 126-a of FIG. 2 displayed in a full screen mode. In this illustrative example, the content redirector 118 identifies contextual information 170 that is presented with an immediate set of alternative rules to inform the continuation of the content feed 160. These alternatives are presented contextually and dynamically, and the alternatives are based on the displayed content item 126. In various examples, a set of contextual options 174 is presented to the user on the display 152 that includes the content item 126, and thus access to the mechanism is instantaneous and spontaneous. The set of contextual options 174 is selected from the contextual identifiers 172 associated with contextual information 170 of the displayed content item 126. In effect, by selecting one of the presented alternatives, the user has immediately on the spot changed what will come next in the content feed, hence directed the user experience to an alternative path of content. The set of contextual options 174 can also include an option to restore a previous content feed associated with the user feed history 130 or other information.

There is no limit to how many times this mechanism is used in any social media content scrolling session. Each time the user places focus on a piece of content in the user feed, the content redirector 118 dynamically updates with a set of contextual options 174 that can be selected to further change what comes next. Thus a user, for example, might start a social media content scrolling session scrolling content that is focused on the activity hiking, but upon viewing a piece of content taking place in Stone Mountain GA, they may decide to change or modify the content feed 160 to content related to Stone Mountain, and upon further scrolling through Stone Mountain related content, they may see a piece of content presented by a user that they find particularly compelling, and once again to choose to change the content feed again, this time to all content posted by a particular user and similar users. Additionally, the requests to modify content are stored in a user feed history 130, which enables the user to restore a previous content feed associated with the user feed history 130 and/or other information.

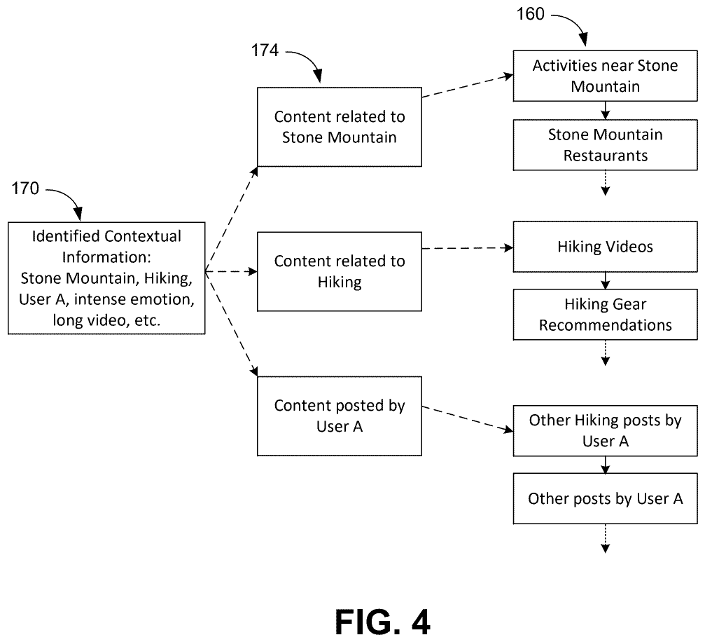

FIG. 4 illustrates an example of possible content paths based on the first social media post 162-a shown in FIGS. 2 and 3. In this example, the contextual information 170 identified as related to the post 162-a can include Stone Mountain (geographic location), hiking (nature of the activity), User A (user that posted the content), intense emotion (tagged item), and/or long video (format), among other identifiers. Based on the context rules 128, several contextual options 174 can be presented to the user, including a restore option (e.g. “Back”) to restore a previous content feed associated with the redirect history 130 or other information. Based on the selected option, the content redirector 118 can modify the user content feed to show content prioritized with the selected contextual option. For example, content related to the Stone Mountain (e.g. location) may include activities near Stone Mountain, Stone Mountain restaurants, other image or videos of Stone Mountain, and the like. Content related to hiking (e.g. activity) may include other hiking videos, hiking gear recommendations, other hiking destinations, and the like. Content related to User A may include other hiking content by User A, other posts by User A, other content similar to posts by User A, and the like. The requested contextual information can be used by the recommender 116 to update future user content feed for the requesting user.

Although the example shown in FIG. 3 illustrates selectable contextual options to redirect the content feed, other input means can be relied upon for the content redirector 118. In various embodiments, the social networking platform 110 can be configured to receive contextual identifiers 172 in a conversational manner with an AI agent. Thus, contextual identifiers 172 for content direction can be input via a chat interface by either typing into a chat prompt or by directly speaking into the client device. For example, the user may request a redirection by speaking “show me couples hiking in awesome mountain ranges.” Alternatively, the request can be made via text in a prompt box. If the user would like to revert to a previous content feed, the user can say “go back” or type back in a prompt box.

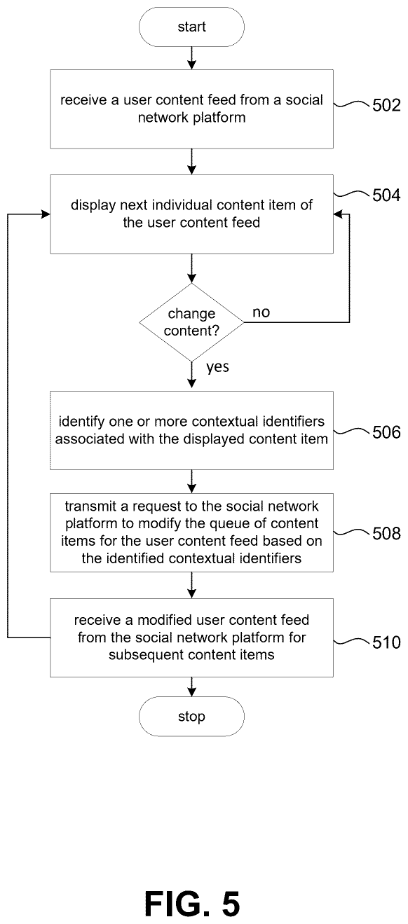

Referring next to FIG. 5, shown is a flowchart that provides one example of the operation of a portion of the client application 154 according to various embodiments. It is understood that the flowchart of FIG. 5 provides merely an example of the many different types of functional arrangements that may be employed to implement the operation of the portion of the client application 154 as described herein. As an alternative, the flow chart of FIG. 5 may be view as depicting an example of elements of a method implemented in the client 150 (FIG. 1) according to one or more embodiments.

In FIG. 5, an illustrative computer implemented method is shown. At box 502, a computer implemented method can include receiving a user content feed from a social network platform 112, wherein the user content feed 160 includes a sequence of content items 126 queued for display within a user interface 156 of client application 154 on a display of a client device 150 of a user.

At box 504, the computer-implemented method can further include displaying individual content items of the user content feed in succession in the user interface 156. In the initial user content feed 160, the first content item 126 is displayed, followed by subsequent content items 126 of the content feed 160. The user interface 156 is configured to allow the user control of the duration of time that the individual content item 126 of the content feed 160 is substantially within a viewing area of the display 152. The client application 154 is configured to receive input from the user regarding displayed content item. In various embodiments, the client application 154 is configured to receive user input via the user interface of the social media application via speech input.

At box 506, the computer-implemented method can further include identifying one or more contextual identifiers 172 associated with contextual information 170 of the displayed content item 126. In various examples, the contextual identifiers 172 can be determined by the content redirector 118 and selected by the user. In various examples, the contextual identifiers 172 can be determined by the user and input by the user via the interface. In some examples, the user interface can be configured to receive input via speech input. In various embodiments, the user can optionally input a contextual identifier 172 not related to the displayed content item 126 to redirect the content feed to another topic.

In response to a user input via the user interface 156, at box 508, the computer-implemented method can further include transmitting a request to the social network platform 112 to update the queue of content items for the user content feed 160. The request includes one or more contextual identifiers 172 based on the user input, where the contextual identifiers 172 are associated with the displayed content item substantially within the selection area. For example, the one or more contextual identifiers 172 associated with the displayed content is embedded within the metadata of the digital content. Alternatively, the one or more contextual identifiers associated with the displayed content can include information indicated by an author of the digital content. In other examples, the one or more contextual identifiers 172 can be determined by the user of the client device. In various embodiments, the one or more contextual identifiers 172 are predetermined by the social network platform 112 and received in conjunction with the individual content items 126 and the client application 152 is configured to present the predetermined contextual identifiers 172 is a manner selectable by the user. For example, the contextual identifiers 172 can be determined using artificial intelligence, computer vision, and/or machine learning and presented to the user via the client application.

At box 510, the computer-implemented method can further include receiving a modified user content feed from the social network platform for subsequent content items based on the one or more contextual identifiers 172 transmitted with the user input. The computer-implemented method can further include displaying individual content items of the modified user content feed in succession, wherein the user can continue to have the option to modify the content feed with each content item 126.

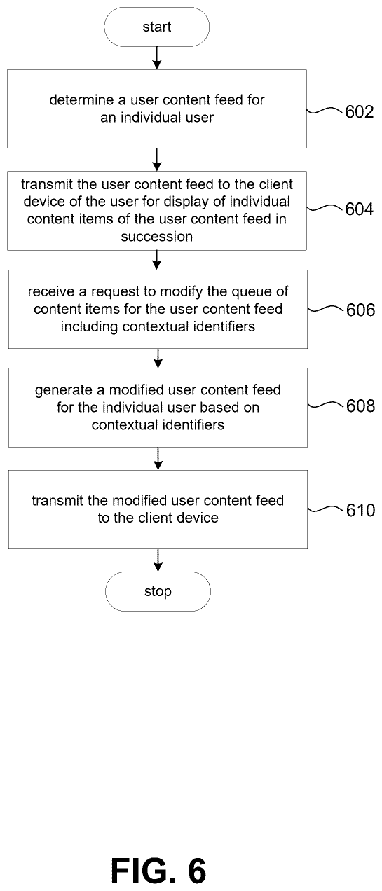

Referring next to FIG. 6, shown is a flowchart that provides one example of the operation of a portion of the social media application 112 according to various embodiments. It is understood that the flowchart of FIG. 6 provides merely an example of the many different types of functional arrangements that may be employed to implement the operation of the portion of the social media application 112 as described herein. As an alternative, the flow chart of FIG. 6 may be view as depicting an example of elements of a method implemented in the social networking platform 110 (FIG. 1) according to one or more embodiments.

In FIG. 6, an illustrative computer implemented method is shown. At box 602, a computer implemented method can include determining a user content feed for an individual user. The content manager 114 provide a user content feed 160 via the social media application 112, wherein the user content feed 160 includes a sequence of content items 126 queued for display within a user interface 156 of the social media client application 154 on a display 152 of a client device 150 of the user. The content feed 160 can be determined by the recommender 116 based on the individual user profile 124 and/or other information. For example, the recommender 116 can utilize algorithms, machine learning, and/or artificial intelligence to recommend user content based on at least the individual user profile data 124.

At box 604, the computer implemented method can further include transmitting the user content feed 160 to the client device 150 of the user for display of individual content items 126 of the user content feed 160 in succession. In some embodiments, transmitting the user content feed 160 can also include transmitting predetermined contextual identifiers 172 associated with the content item along with corresponding content items 126 of the user content feed. For example, the contextual identifiers 172 can be determined using artificial intelligence, computer vision, and/or machine learning.

At box 606, the computer implemented method can further include receiving a request to modify the queue of content items for the user content feed, wherein the request includes one or more contextual identifiers 172 associated with a displayed content item. For example, the one or more contextual identifiers 172 associated with the displayed content can be indicated by an author of the digital content. The one or more contextual identifiers 172 can be indicated by metadata of the digital content. In another example, the user may select predetermined contextual identifiers 172 associated with the content item. The user of the client device can also determine one or more contextual identifiers 172 associated with the displayed content based on other information.

At box 608, the computer implemented method can further include generating a modified user content feed for the individual user based on the one or more contextual identifiers 172 associated with a displayed content item. In various embodiments, determining a modified user content feed can also include updating the contextual identifiers 172 associated with a displayed content item received with the request to modify the queue of content items for the user content feed. The modified user content feed can include the same or different content items that were in the previously presented user content feed. For example, new content items can be selected based on the one or more contextual identifiers 172 associated with a displayed content item, where the new content items are given a higher priority and ordered to be displayed the among the next content items in the modified user content feed. In another example, the same or similar content items of the present user content feed can be reordered changing the sequence of individual content items in the modified content feed. Additionally, the information related to the request can be stored in the redirect history. For example, the redirect history information can include feed information related to the presented user content feed and the modified user content feed. The redirect history information can include information related to a plurality of previous requests. For example, the redirect history information can be used to restore a previous user content feed.

At box 610, the computer implemented method can further include transmitting the modified user content feed to the client device of the user for display of individual content items of the user content feed in succession. The modified user content feed does not necessarily change the content items that have been displayed to the user, retaining the history of previously presented items.

As described herein, the methods illustrated in FIGS. 5 and 6 are illustrative examples and can include more or less steps than shown, or can include steps executed in a different order. Additionally, a non-transitory computer-readable medium embodying a program executable in at least one computing device, wherein when executing the program causes the at least one computing device to at least implement the computer implemented methods as shown and described herein.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

What is claimed is:

1. A computer implemented method, comprising:
receiving a user content feed from a social network platform, wherein the user content feed includes a sequence of content items queued for display within a user interface of client application on a display of a client device of a user;
displaying individual content items of the user content feed in succession in the user interface, wherein the user controls the duration of time that the individual content item of the content feed is substantially within a viewing area of the display;
in response to a user input via the user interface, transmitting a request to the social network platform to update the queue of content items for the user content feed, wherein the request includes one or more contextual identifiers associated with the displayed content item substantially within the selection area;
receiving a modified user content feed from the social network platform for subsequent content items based on the one or more contextual identifiers; and
displaying individual content items of the modified user content feed in succession.

2. The computer implemented method of claim 1, wherein the one or more contextual identifiers associated with the displayed content is embedded within the metadata of the digital content.

3. The computer implemented method of claim 1, wherein the one or more contextual identifiers associated with the displayed content is indicated by an author of the digital content.

4. The computer implemented method of claim 1, wherein the one or more contextual identifiers associated with the displayed content is determined by the user of the client device.

5. The computer implemented method of claim 1, wherein the one or more contextual identifiers associated with the displayed content item is predetermined by the social network platform and received in conjunction with the individual content items, and the social media application presents the predetermined contextual identifiers is a manner selectable by the user.

6. The computer implemented method of claim 1, wherein the user input is received via the user interface of the social media application via speech input.

7. The computer implemented method of claim 1, wherein the contextual identifiers are determined using artificial intelligence, computer vision, and/or machine learning.

8. A non-transitory computer-readable medium embodying a program executable in at least one computing device, wherein when executed the program causes the at least one computing device to at least implement the method of claim 1.

9. A system comprising:
at least one computing device; and
instructions executable in the at least one computing device, wherein when executed the instructions cause the at least one computing device to at least:
receive a user content feed from a social network platform, wherein the user content feed includes a sequence of content items queued for display within a social media application on a display of a client device of a user;
display individual content items of the user content feed in succession, wherein a user controls the duration of time that individual content items of the content feed is substantially within a selection area of the display;
in response to a user input via the social media application, transmit a request to the social network platform to update the queue of content items for the user content feed, wherein the request includes one or more contextual identifiers associated with the displayed content item substantially within the selection area;
receive a update user content feed from the social network platform for subsequent content items based on the one or more contextual identifiers; and
display individual content items of the modified user content feed in succession.

10. A computer implemented method, comprising:
determining a user content feed for an individual user, wherein the user content feed includes a sequence of content items queued for display within a social media application on a display of a client device of the user;
transmitting the user content feed to the client device of the user for display of individual content items of the user content feed in succession;
receiving a request to modify the queue of content items for the user content feed, wherein the request includes one or more contextual identifiers associated with a displayed content item;
determining a modified user content feed for the individual user based on the one or more contextual identifiers associated with a displayed content item; and
transmitting the modified user content feed to the client device of the user for display of individual content items of the user content feed in succession.

11. The computer implemented method of claim 10, further comprising transmitting predetermined contextual identifiers associated with the displayed content item along with corresponding content items of the user content feed.

12. The computer implemented method of claim 10, further comprising updating the contextual identifiers associated with a displayed content item received with the request to modify the queue of content items for the user content feed.

13. The computer implemented method of claim 11, wherein the contextual identifiers are determined using artificial intelligence, computer vision, and/or machine learning.

14. The computer implemented method of claim 10, wherein the one or more contextual identifiers associated with the displayed content is indicated by an author of the digital content.

15. The computer implemented method of claim 10, wherein the one or more contextual identifiers associated with the displayed content is determined by the user of the client device.

16. A non-transitory computer-readable medium embodying a program executable in at least one computing device, wherein when executed the program causes the at least one computing device to at least implement the method of claim 10.

17. A system comprising:
at least one computing device; and
instructions executable in the at least one computing device, wherein when executed the instructions cause the at least one computing device to at least:
determine a user content feed for an individual user, wherein the user content feed includes a sequence of content items queued for display within a social media application on a display of a client device of the user;
transmit the user content feed to the client device of the user for display of individual content items of the user content feed in succession;
receive a request to modify the queue of content items for the user content feed, wherein the request includes one or more contextual identifiers associated with a displayed content item;
determine a modified user content feed for the individual user based on the one or more contextual identifiers associated with a displayed content item; and
transmit the modified user content feed to the client device of the user for display of individual content items of the user content feed in succession.

18. A computer implemented method, comprising:
determining a user content feed for an individual user, wherein the user content feed includes a sequence of content items queued for display within a social media application on a display of a client device of the user;
transmitting the user content feed to the client device of the user for display of individual content items of the user content feed in succession;
receiving a request to modify the queue of content items for the user content feed;
determining a modified user content feed for the individual user based on the request;
storing redirect history information related to the request in a user feed history; and
transmitting the modified user content feed to the client device of the user for display of individual content items of the user content feed in succession.

19. The computer implemented method of claim 18, wherein the user feed history includes feed information related to the user content feed and the modified user content feed including the redirect history information.

20. The computer implemented method of claim 18, wherein the user feed history includes information related to a plurality of previous requests to modify the queue of content items for the user content feed.
